(19) United States
(12) Patent Application Publication
(10) Pub. No.: US 2019/0382620 A1
(43) Pub. Date: Dec. 19, 2019

(54) HIGH PERFORMANCE HOT MELT ADHESIVES AND USES THEREOF

(71) Applicant: HENKEL IP & HOLDING GMBH, Duesseldorf (DE)

(72) Inventors: Chuiwah Alice Cheung, Hillsborough, NJ (US); Michael Harwell, Flemington, NJ (US); Andrea Maria Paredes Torres, Belle Mead, NJ (US)

(21) Appl. No.: 16/556,527

(22) Filed: Aug. 30, 2019

Related U.S. Application Data
(63) Continuation of application No. PCT/US18/26636, filed on Apr. 7, 2018.
(60) Provisional application No. 62/482,953, filed on Apr. 7, 2017.

(51) Int. Cl. C09J 5/06; C09J 153/00; C09J 11/08; C09J 11/06; B32B 7/12; B32B 27/32; B32B 37/12

(52) U.S. Cl. CPC C09J 5/06; C09J 153/00; C09J 11/08; C09J 11/06; B32B 7/12; B32B 27/32; B32B 2037/1223; B32B 37/1207; C09J 2453/00; C09J 2491/00; C09J 2493/00; C09J 2400/286; B32B 37/1284

(57) ABSTRACT

A high performance hot melt adhesive composition with higher heat stress and higher adhesion values at lower temperatures than a conventional hot melt adhesive is provided. Smaller quantities of the high performance hot melt may be used to provide similar performances as conventional hot melt adhesives.

### FIELD OF THE INVENTION

The invention relates to high performance hot melt adhesives, suitable for container labels, and carton and case sealing. The high performance hot melt adhesives have higher heat stress and adhesion at lower temperatures on cellulosic substrates than conventional hot melt adhesives.

### BACKGROUND OF THE INVENTION

Hot melt adhesive is a thermoplastic material that is solid at room temperature, and when applied in a molten state, adheres to a substrate as it solidifies. Hot melt adhesive forms an initial bond and green strength with light contact pressure. Over time, the hot melt adhesive forms a strong bond strength with the substrate. The bond strength increases as the amount of the applied adhesive on the substrate is increased.

The primary raw materials used to manufacture hot melt adhesives are polymers, tackifiers, diluents and waxes. The raw materials are typically synthesized from petroleum, using energy-intensive processes. In addition, a large percentage of the petroleum is transported from various parts of the world, which increases the carbon footprint.

To decrease petroleum intensive carbon footprint, ethylene vinyl acetate (EVA) based adhesives have been replaced with olefin-based adhesives. Due to the lower density of olefin-based adhesives over EVA-based adhesives, reduced weight of the adhesives has been used to realize similar performances; however overall volume of the adhesive to bond has not changed.

There is an increased desire to reduce carbon footprint and to produce a product that has higher efficiency and performance. One method of making environmentally sound adhesives is to decrease carbon footprint by forming the hot melt adhesives with improved bond strength. The current invention fulfills this need.

### BRIEF SUMMARY OF THE INVENTION

The invention provides a high performance hot melt adhesive composition with higher heat stress and higher adhesion values at lower temperatures than a conventional hot melt adhesive. In another aspect, the invention provides an article with similar adhesion strength with lower quantities of high performance hot melt adhesive than a conventional hot melt adhesive.

One aspect of the invention is directed to a high performance hot melt adhesive composition comprising:
(A) about 20 wt % to about 50 wt % of a polymer having (i) a melting point of about 105 to about 150° C. and (ii) a glass transition temperature of about −80 to about −50° C.;
(B) about 20 to about 40 wt % of a wax;
(C) about 30 to about 70 wt % of a tackifier; and
(D) about 0.01 to about 3 wt % of an antioxidant.
   The hot melt adhesive is substantially free of any plasticizer and is substantially free of any polymer having a DSC melting point of below about 105° C.

In another aspect, the invention provides an article comprising two cellulosic substrates with an adhesive interposed in between the two substrates. The adhesive is a high performance hot melt adhesive composition comprising:
(A) about 20 wt % to about 50 wt % of a polymer having (i) a melting point of about 105 to about 150° C. and (ii) a glass transition temperature of about −80 to about −50° C.;
(B) about 20 to about 40 wt % of a wax;
(C) about 30 to about 70 wt % of a tackifier; and
(D) about 0.01 to about 3 wt % of an antioxidant.
   The hot melt adhesive is substantially free of any plasticizer and is substantially free of any polymer having a DSC melting point of below about 105° C. The high performance hot melt adhesive has a heat stress value greater than 140° F. and has an adhesion tear value greater than 80% measured at −20° F. with bead weight of 0.075 g/in.

Another aspect of the invention is directed to a process for manufacturing an article comprising the steps of:
(A) forming a high performance adhesive composition comprising (i) about 20 wt % to about 50 wt % of a polymer having (a) a melting point of about 105 to about 140° C. and (b) a glass transition temperature of about −80 to about −50° C.; (ii) about 30 to about 20 wt % of a wax; (iii) about 30 to about 70 wt % of a tackifier; and (iv) about 0.01 to about 3 wt % of an antioxidant;
(B) applying the adhesive onto a substrate at about 275° F. to about 400° F.; and
(C) applying a second substrate onto the applied adhesive.
   The hot melt adhesive is substantially free of any plasticizer and is substantially free of any polymer having a DSC melting point of below about 105° C. The substrate may be a paper, paperboard, plastic film, metal foil, release paper, cotton, or nonwoven fabric.

### DETAILED DESCRIPTION OF THE INVENTION

The present invention provides high performance hot melt adhesives. The hot melt adhesive provides superior heat stress and adhesion at lower temperatures, and thereby lower quantities of the same adhesive may be used to adhere substrates together to have similar performances as conventional hot melt adhesives.

The term, “essentially free” means that the hot melt adhesive composition comprises less than 0.1 wt % of the named component, less than 0.01 wt % of the named component, trace amount of the named component, or undetectable amount of named component in the hot melt adhesive. In another aspect, the term “essentially free” indicates that the named component was not intended to be added to the hot melt adhesive composition.

The term, “conventional hot melt adhesive” or “conventional adhesives” means adhesives with plasticizers, EVAs or polymers having DSC melting point less than 105° C.

The high performance hot melt adhesive composition comprises a polymer having (i) a DSC melting point of about 105 to about 150° C. and (ii) a glass transition temperature of about −80 to about −50° C. In another embodiment, the polymer has a DSC melting point greater than about 106, 107, 108, 109, 110, 111, 112, 113, 114, 115, 116, 117, 118, 119, 120, 121, 122, 123, 1234, 125, 126, 127, 129, 130, 131, 132, 133, 134, 135, 136, 137, 138, 139, 140, 141, 142, 143, 145, 146, 147, 148 or 149° C.

The DSC melting temperature is measured by various known means in the art. The DSC melting temperature values given herein is measured with TA Instruments Universal Analysis 2000 Differential Scanning Calorimeter (DSC). About 5-10 mg of sample was enclosed in hermetically sealed aluminum pans and run against an empty pan as reference with nitrogen gas as the carrier gas. The sample was heated above the sample melting point, typically up to 220° C., and held isotherm for 2 minutes. The sample was rapidly cooled to −90° C. and held for 1 minute. The sample was then heated at a rate of 10° C./min. The melting temperature was taken as the peak of the melting endotherms.

The Tg of the polymer can be determined by differential scanning calorimetry (DSC). About 5-10 mg of sample was enclosed in hermetically sealed aluminum pans and tested against a reference an empty pan with nitrogen gas as the carrier gas. The sample was heated above the sample melting point, typically up to 220° C., and held isotherm for 2 minutes. The sample was rapidly cooled to −90° C. and held for 1 minute. The sample was then heated at a rate of 10° C./min. The Tg is calculated as the midpoint between the onset and endpoint of heat flow change corresponding to the glass transition on the DSC heat capacity heating curve. The use of DSC to determine Tg is well known in the art, and is described by B. Cassel and M. P. DiVito in “Use of DSC To Obtain Accurate Thermodynamic and Kinetic Data”, American Laboratory, January 1994, pp 14-19, and by B. Wunderlich in Thermal Analysis, Academic Press, Inc., 1990.

In one embodiment, the polymer comprises a copolymer of ethylene and at least one comonomer selected from C₃₋₁₂ alpha-olefins. In another embodiment, the polymer comprises a copolymer of propylene and at least one comonomer selected from C_{2, 4-12} alpha-olefins. In one particular embodiment, polymer component is an ethylene-octene comonomer. The melt index greater than about 5 to about 2,500 g/10 min at 190° C. measured in accordance with ASTM D1238.

In another embodiment, the polymer is an alternating blocks of rigid and elastomeric segments component is an olefin block copolymer (OBC) produced by chain shuttling process. OBC has blocks of “hard” (highly rigid crystalline) and “soft” (highly elastomeric amorphous) segments. U.S. Pat. No. 7,524,911 and WO 2009/029476 describe adhesive compositions based on OBC. Other references that describe OBC's and various applications for OBC's include WO 2006/101966, WO 2006/102016, WO 2008/005501, and WO 2008/067503. Details of their synthesis and physical properties can be found in, for example, WO 2006/102150, WO 2009/029476 and U.S. Pat. No. 7,524,911, the disclosures of which are specifically incorporated herein by reference. As is known in the art, the density of the OBC is directly related to its crystallinity, i.e. the higher the density the higher the percent crystallinity. OBC's useful in the present hot melt adhesive composition have densities ranging from 0.860 g/cm³ to 0.890 g/em³ (g/cc) and a melt index of 1 g/10 min. to 1000 g/10 min, preferably 1 g/10 min to 100 g/10 min. as measured according to ASTM. D1238 at 0.190° C. with a 2.16 kg weight. The olefin block copolymer has a weight average molecular weight (Mw) of 15,000 to 100,000 g/mol or preferably of 20,000 to 75,000 g/mol.

Blends of two or more OBC polymers may also be used. For example, a blend of a first OBC polymer and a second OBC polymer that is different than the first OBC polymer may be employed.

OBC polymers are commercially available from Dow Chemical Company under the tradename INFUSE in various grades.

The polymer is present in the high performance hot melt adhesive composition in the range of about 20 to about 50 wt %, based on the total weight of the adhesive. Preferably, the polymer is present at levels of greater than about 20, 21, 22, 23, 24, 25, 26, 27, 28, 29, 30, 31, 32, 33, 34, 35, 36, 37, 38, 39, 40, 41, 42, 43, 44, 45, 46, 47, 48 or 49 wt %.

The high performance hot melt adhesive is substantially free of any polymer having a DSC melting point less than 105° C.

The high performance hot melt adhesive composition further comprises a wax. Waxes suitable for use in the present invention include paraffin waxes, microcrystalline waxes, polyethylene waxes, polypropylene waxes, by-product polyethylene waxes, Fischer-Tropsch waxes, oxidized Fischer-Tropsch waxes and functionalized waxes such as hydroxy stearamide waxes and fatty amide waxes. High density low molecular weight polyethylene waxes, by-product polyethylene waxes and Fischer-Tropsch waxes are conventionally referred to in the art as synthetic high melting point waxes.

When used, the wax component will typically be present in amounts of from about 20 to about 40 wt %, based on the total weight of the adhesive. Preferred waxes have a melt temperature between 49° C. and 121° C., more preferably between 66° C. and 110° C., and most preferable between 82° C. and 104° C.

The high performance hot melt adhesive composition further comprises a tackifier. Tackifier is chosen based on the polymer of the adhesive. Compatibility with the polymer, softening point, viscosity and cytotoxicity to skin sensitivity are primary factors in choosing a particular tackifier. A combination of tackifiers may be used in the adhesive. The tackifier component may typically be present from about 20 to about 70 wt %, preferably from about 30 to about 60 wt %, based on the total weight of the adhesive.

Typical tackifiers have Ring and Ball softening points, as determined by ASTM method E28, of about 40° C. to about 150° C., more preferably of about 80° C. to about 130° C.

Useful tackifying resins may include any compatible resin or mixtures thereof, such as synthetic hydrocarbon resins and mixtures. Included are aliphatic or cycloaliphatic hydrocarbons, aromatic hydrocarbons, aromatically modified aliphatic or cycloaliphatic hydrocarbons, the hydrogenated derivatives thereof. Aliphatic hydrocarbons C5 tackifying resin in this class is a diene-olefin copolymer of piperylene and 2-methyl-2-butene having a softening point of about 95° C. Examples of this resin are Wingtack 95 ® from Cray Valley, Escorez™ 1304 from Exxon Mobil Chemicals, Piccotac™ 1095 from Eastman, and HAITACK™ JH 3201 from Jinhai. Cycloaliphatic hydrocarbons C5 tackifying resin is available commercially under the trade name of Quintone® 100 series and 300 series from Zeon. Aromatically modified aliphatic hydrocarbons resins such as those available from Cray Valley under the trade name of WINGTACK® Extra, WINGTACK® Plus, WINGTACK® ET, Escorez™ 2203LC from Exxon Mobil Chemicals, Piccotac™ 9095 from Eastman, and HAITACK™ JH 3200 from Jinhai are also useful in the invention. Examples of hydrogenated tackifiers particularly suitable include Escorez 5000 series from Exxon Mobil Chemicals, Arkon P100 from Arakawa and Regalite S1100 or Eastotac H100 from Eastman Chemical, and the like. Also included are the cyclic or acyclic C5 resins and aromatic modified acyclic or cyclic resins.

Alpha methyl styrene resins such as Kristalex 3085 and 3100 from Eastman Chemicals, Sylvares SA 100 from Arizona chemicals are also useful as tackifiers in the invention. Mixtures of two or more described tackifying resins may be required for some formulations.

Also useful are aromatic hydrocarbon resins that are C9 aromatic/aliphatic olefin-derived and available from Cray Valley under the trade name Norsolene® and from Rutgers series of TK aromatic hydrocarbon resins. Norsolene® A-90 is a low molecular weight aliphatic C9 hydrocarbon resin having a Ring and Ball softening point of 90-100° C. and is commercially available from Cray Valley.

In one embodiment, the tackifiers are natural and modified rosins including, for example, as gum rosin, wood rosin, tall oil rosin, distilled rosin, hydrogenated rosin, dimerized rosin, resinates, and polymerized rosin; glycerol and pentaerythritol esters of natural and modified rosins, including, for example as the glycerol ester of pale, wood rosin, the glycerol ester of hydrogenated rosin, the glycerol ester of polymerized rosin, the pentaerythritol ester of hydrogenated rosin. Examples of commercially available rosins and rosin derivatives that could be used to practice the invention include SYLVALITE® RE 100L, SYLVALITE® RE 110L, and SYLVATAC® RE 85 available from Arizona Chemical; Westrez® 5101 from Ingevity, and NovaRes® 1100 from Georgia-Pacific. Another tackifiers include copolymers and terpolymers of natured terpenes, including, for example, styrene/terpene and alpha methyl styrene/terpene; polyterpene resins having a softening point, as determined by ASTM method E28-58T, of from about 70° C. to 150° C. Examples of commercially available styrene/terpene resin are SYLVARES™ ZT 106LT from Arizona Chemical and Piccolyte® HM106 from Pinova. Other tackifiers are phenolic modified terpene resins and hydrogenated derivatives thereof including, for example, the resin product resulting from the condensation, in an acidic medium, of a bicyclic terpene and a phenol; aliphatic petroleum hydrocarbon resins having a Ball and Ring softening point of from about 70° C. to 135° C. Examples of commercially available phenolic modified terpene resins are Sylvares TP 2040 HM and Sylvares TP 300, both available from Arizona Chemical.

The adhesives of the invention also comprise an antioxidant, stabilizer and/or additive.

Antioxidants are added to protect the adhesive from degradation caused by reaction with oxygen induced by heat, light, or residual catalyst from the raw materials such as the tackifying resin.

The applicable antioxidants included herein are high molecular weight hindered phenols and multifunctional phenols such as sulfur and phosphorous-containing phenol. Hindered phenols are well known to those skilled in the art and may be characterized as phenolic compounds which also contain sterically bulky radicals in close proximity to the phenolic hydroxyl group thereof. In particular, tertiary butyl groups generally are substituted onto the benzene ring in at least one of the ortho positions relative to the phenolic hydroxyl group. The presence of these sterically bulky substituted radicals in the vicinity of the hydroxyl group serves to retard its stretching frequency, and correspondingly, its reactivity; this hindrance thus providing the phenolic compound with its stabilizing properties. Representative hindered phenols include; 1,3,5-trimethyl-2,4,6-tris-(3,5-di-tert-butyl-4-hydroxybenzyl)-benzene; pentaerythrityl tetrakis-3(3,5-d i-tert-butyl-4-hydroxyphenyl)-propionate; n-octadecyl-3(3,5-di-tert-butyl-4-hydroxyphenyl)-propionate; 4,4′-methylenebis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5 triazine; di-n-octylthio)ethyl 3,5-di-tert-butyl-4-hydroxy-benzoate; and sorbitol hexa[3-(3,5-d i-tert-butyl-4-hydroxy-phenyl)-propionate].

Such antioxidants are commercially available from BASF and include IRGANOX (Registered trademark) 565, 1010, 1076 and 1726 which are hindered phenols. These are primary antioxidants which act as radical scavengers and may be used alone or in combination with other antioxidants such as phosphite antioxidants like IRGAFOS (Registered trademark) 168 available from BASF. Phosphite catalysts are considered secondary catalysts and are not generally used alone. These are primarily used as peroxide decomposers. Other available catalysts are CYANOX (Registered trademark) LTDP available from Cytec Industries and ETHANOX (Registered trademark) 330 available from Albemarle Corp. Many such antioxidants are available either to be used alone or in combination with other such antioxidants. These compounds are added to the hot melts in small amounts, typically less than about 10 wt %, based on the adhesive, and have no effect on other physical properties. Other compounds that could be added that also do not affect physical properties are pigments which add color, or fluorescing agents, to mention only a couple. Additives like these are known to those skilled in the art.

Depending on the contemplated end uses of the hot melt adhesive, other additives such as pigments, dyestuffs and fillers conventionally added to hot melt adhesives may be incorporated in minor amounts, i.e., up to about 10% by weight, into the formulations of the present invention.

Other additives include fillers, solvents (for improving film forming and wettability properties), polymeric additives, defoamers, surfactants, crosslinkers and biocides, coupling agent, ozone protectant, fatty acids, nucleating agents, blowing agents, thickeners, rheology modifiers, humectants, nucleating agent, antiblock, processing aids, UV stabilizers, neutralizers, lubricants, and adhesion promoter and/or accelerators may be incorporated in the polymer, which may be incorporated in minor or larger amounts into the adhesive formulation, depending on the purpose.

The high performance hot melt adhesive is substantially free of any plasticizers, liquid or solid, including any oil or polybutenes. The addition of plasticizers lowers the viscosity, particularly for adhesives with viscosity levels higher than 1,500 cPs. The high performance hot melt adhesive is also substantially free of polymers having a DSC melting temperature less than about 105° C. Plasticizers and polymers are typically synthesized from petroleum, using energy-intensive processes, which increases the carbon footprint.

Conventional hot melt adhesives that typically have a viscosity less than 1,000 cPs at 350° F. In a preferred mode, the high performance hot melt adhesive composition has an initial viscosity (or melt viscosity) at 350° F. of about 2,500 to about 10,000 cPs, preferably about 3,000 to about 9,000 cPs. The viscosity (or melt viscosity) at 350° F. herein means a value measured by a Brookfield viscometer using a No. 27 spindle.

The method for applying the hot melt adhesive is not particularly limited. The adhesive is first prepared by combining the polymer, wax and tackifier and melting them above the molten temperature, adding other components, until they are combined. The adhesive may be pelletized and cooled at this point and reheated to a molten state, or may be directly applied onto a substrate. The prepared molten adhesive is applied onto a first substrate and then a second substrate is applied onto the adhesive, whereby the adhesive is interposed between the two substrates.

The high performance hot melt adhesive may be applied in various forms known in the art. In one embodiment, the adhesive is applied onto the substrate in a line, stitch or dots patterns. The adhesive may be applied in 0.01 g/in to 0.30 g/in as add-on amounts.

Substrates include virgin and recycled Kraft paper, high and low density Kraft, chipboard and various types of treated and coated Kraft and chipboard, plastic film, wood, metal foil, release paper, cotton, nonwoven fabric, composite materials and the like. These composite materials may include chipboard laminated to an aluminum foil which is further laminated to film materials such as polyethylene, Mylar, polypropylene, polyvinylidene chloride, ethylene vinyl acetate and various other types of film.

The high performance hot melt adhesive has heat stress value or above 140° F. Heat stress test is a way to predict whether the adhesive bond integrity will be maintained at elevated temperatures. This bond is exposed to thermal and mechanical stresses, and the highest temperature at which the bond maintains its integrity is determined as the heat stress value. Heat stress is measured using the industry-standard IoPP (Institute of Packaging Professionals) heat stress test by (1) applying a pre-determined quantity of hot melt onto a substrate and adhering a second substrate onto the hot melt to form an article; (2) applying force to the bonded article; (3) exposing the article to an elevated temperature (in an oven) for 24 hours; and (4) repeating steps (1) to (3) and recording the maximum temperature at which the bond could hold the substrates together against the weight.

The high performance hot melt adhesive has superior adhesion at low temperatures, in the range of about −20° F. to 20° F. Typically, as adhesive is cooled, it becomes more rigid and fails to maintain the bond at low temperatures. The low adhesion is a predictor on whether the adhesive bond integrity will be maintained at low temperatures. The low adhesion value is measured by (1) applying a pre-determined quantity of hot melt onto a substrate and adhering a second substrate onto the hot melt to form an article; (2) applying a force to the bonded article; (3) exposing the article to a set low temperature for 24 hours; and (4) analyzing the bond for failure by pulling apart the bond.

Due to the higher heat stress and superior adhesion, the high performance hot melt adhesive, in one embodiment, may be used in lower quantities than conventional adhesives with similar adhesion performances. The high performance adhesive may be reduced by 10, 20 30, 40 or even 50 wt % (and all intervening wt %) than conventional adhesive, and the high performance adhesive still provide similar adhesion performances.

The high performance hot melt adhesive is particularly useful as a fast setting and non-pressure sensitive adhesive for packaging articles. The hot melt adhesive may be widely used in converting, cigarette manufacture, bookbinding, bag ending and in nonwoven markets. The adhesive finds particular use as cardboard case, carton, and tray forming adhesives, and as sealing adhesives, including heat sealing applications, for example in the packaging of cereals, cracker and beer products. Encompassed by the invention are containers, e.g., cartons, cases, boxes, bags, graphic arts, sealers, trays and the like, wherein the adhesive is applied by the manufacturer thereof prior to shipment to the packager.

The present invention may be better understood through analysis of the following examples, which are non-limiting and are intended only to help explain the invention.

### Examples

Table 1 lists various polymer and their DSC melting temperatures Tm and glass transition (Tg) values.

TABLE 1
Components

| | | Tm | Tg |
|---|---|---|---|
| Polymer | Description | (° C.) | (° C.) |
| Olefin Block | Density of 0.866 g/cm³, Melt index | | |
| Copolymer | 15 g/10 min (2.16 kg @190° C.) | 123 | −63 |
| Olefin | Density of 0.874 g/cm³, Melt index | | |
| interpolymer A | 500 g/10 min (2.16 kg @190° C.) | 70 | −55 |
| Olefin | Density of 0.870 g/cm³, Melt index | | |
| interpolymer B | 1000 g/10 min (2.16 kg @190° C.) | 70 | −55 |
| Olefin | AFFINITY 8407 | | |
| interpolymer C | Density of 0.870 g/cm³, Melt index | | |
| | 30 g/10 min (2.16 kg @190° C.) | 70 | −55 |
| Olefin | Density of 0.870 g/cm³, Melt index | | |
| interpolymer D | 1250 g/10 min (2.16 kg @190° C.) | 70 | −55 |
| EVA A | Density of 0.954 g/cm³, Melt index | | |
| | 5.7 g/10 min (2.16 kg @190° C.); | | |
| | Vinyl acetate content 26.7% | 74 | / |
| EVA B | Density of 0.952 g/cm³, Melt index | | |
| | 25 g/10 min (2.16 kg@190° C.); | | |
| | Vinyl acetate content 27.6% | 67 | / |
| EVA C | Density of 0.952 g/cm³, Melt index | | |
| | 43 g/10 min (2.16 kg @190° C.); | | |
| | Vinyl acetate content 33% | 74 | / |
| EVA D | Density of 0.949 g/cm³, Melt index | | |
| | 43 g/10 min (2.16 kg @190° C.); | | |
| | Vinyl acetate content 27.6% | 67 | / |
| Wax | Mixture of Fischer Troupe waxes | | |
| | having the highest melting point of | | |
| | 109° C. | | |
| Tackifier | Mixture of cycloaliphatic and rosin | | |
| | ester tackifiers having softening point | | |
| | rages of 100-130° C. | | |
| Anti-oxidant | Hindered Phenols | | |

Table 2 lists components to the adhesives and their adhesion properties. The following adhesives were formed by melting the polymer, and then adding the wax, tackifier and antioxidant to the molten polymer until they form a homogenous mixture.

Application temperature is the temperature at which the adhesive was applied onto a substrate.

Viscosity was measured with a Brookfield viscometer using a No. 27 spindle.

Heat stress defined as the temperature at which a stressed bond fails, was measured by forming a composite construction of adhesive between two pieces of corrugated paperboard of 2″×4″ and 2″×6″. At least three test samples were prepared for the test. The test samples were conditioned at room temperature for 24 hours. The adhesive bead forming this composite was then placed under approximately 100 grams of cantilever stress for 24 hours at specific temperatures. The highest temperature at which the adhesive passed the heat stress was recorded

Cold temperature adhesion was measured on Kraft liner substrates. A ⅛″ wide bead (uncompressed) of adhesive was applied at 350° F. to a 2″×3″ piece of double fluted corrugate board, and was immediately brought in contact with a second piece of corrugated to form a bond. A 200-gram weight was immediately placed on the top of the bond for 10 seconds to provide compression. The prepared boards were conditioned at room temperature for 24 hours and then further conditioned at noted temperatures in the table for 24 hours. The bonds were separated by hand and the resulting fiber tear was recorded (higher values indicated better adhesion). Fiber tear was calculated as the amount of fiber left on the surface of the adhesive, which indicates failure within the substrate and not at the interface between the adhesive and the substrate. Three specimens were tested to obtain the average percent fiber tear. It is desirable to have deep fiber tears for it demonstrates good wet-out of the adhesive at the bond line; and shallow tears and cold cracking at the adhesive interfaces are less desirable

Hot tack was measured by was measured at 0.5 and 1.0 second using Kanebo Bond Tester, Model ASM-15N, in kilogram force (Kgf).

Open time of an adhesive is defined as the maximum time an adhesive, after it is dispensed onto a substrate, is left open before a second substrate is placed onto the adhesive and is still able to form a bond between the two substrates. The open time is measured using a Kanebo Bond Tester, Model ASN-15.

Set time of an adhesive is the minimum amount of compression time required for the adhesive to form a bond between two substrates with more than 75% fiber tear when the substrates are pulled part. The set time is measured using a Kanebo Bond Tester, Model ASN-15.

TABLE 2
Adhesives

| | | Comp | Comp | Comp | Comp |
|---|---|---|---|---|---|
| Components | Ex 1 | Ex 1 | Ex 2 | Ex 3 | Ex 4 |
| polymer | OBC | Olefin | OBC, Olefin | EVA | EVA |
| | | Interpolymer | Interpolymer | A, B | C, D |
| | | A, B | D | | |
| Wax | 30 | 20 | 20 | 27.8 | 20 |
| Tackifier | 44.5 | 44.1 | 29.5 | 34.65 | 39.05 |
| Antioxidant | 0.5 | 0.9 | 0.5 | 0.55 | 1.05 |
| Application T | 350 | 350 | 350 | 350 | 350 |
| (° F.) | | | | | |
| Viscosity at | 4625 | 900 | 4750 | 6088 | 4338 |
| 350° F. | | | | | |
| Heat Stress (° F.) | | | | | |
| Straight 0.15 g/in | 150 | 140 | <130 | <120 | <120 |
| Straight | 150 | <140 | | | |
| 0.075 g/in | | | | | |
| Stitch 0.075 g/in | 145 | <140 | | | |
| Cold T Adhesion | Straight adhesive bead; bead weight 0.15 g/in | | | | |
| 20° F. | 95 | 59 | 100 | 96 | 100 |
| 0° F. | 100 | 27 | 100 | 98 | 96 |
| −20° F. | 92 | 15 | 100 | 98 | 99 |
| | Straight adhesive bead; bead weight 0.075 g/in | | | | |
| 20° F. | 100 | 77 | / | | |
| 0° F. | 100 | 20 | / | | |
| −20° F. | 89 | 18 | / | | |
| Hot Tack at 0.5 s | 4.6 | 5.4 | 5.4 | | |
| Hot tack at 1.0 s | 7.2 | 10 | 5.5 | | |
| Open Time (s) | 8 | 10 | 9 | | |
| Set Time (s) | 3.5 | 1.5 | 3.0 | | |

Example 1, prepared with OBC polymer formed a high viscosity (at 350° C.) adhesive with heat stress value of 145° F. and 150° F.

Comparative Example 1 had significantly lower viscosity than Example 1. Comparative Example 1 had similar, albeit lower heat resistance than Example 1. But when the adhesive usage is decreased by 50 wt %, from 0.15 g/in to 0.075 g/in straight or stitch adhesive bead pattern, the heat stress of Comparative Example 1 further decreased while the inventive example maintained heat stress performance. Similarly, the cold temperature adhesion performance of the inventive Example 1 was superior to Comparative Example 1. When the adhesive usage was reduced by 50 wt %, the inventive Example 1 adhesive maintained similar performance to the higher adhesive usage; however, the performance of the Comparative Example 1 deteriorated. Thus, the adhesion performances of Comparative Example 1 adhesive deteriorate significantly as the amount of adhesive is decreased.

The EVA-based adhesives of Comparative Examples 3 and 4 had significantly lower heat stress than the inventive Example 1.

Other adhesives having high viscosity, Comparative Samples 2, 3 and 4, did not result in high heat stress values. EVA-based and mixtures of OBC and olefin interpolymer-based adhesives failed to provide high heat performances.

The high performance hot melt adhesive prepared as set forth in Example 1 resulted in broad service temperature with high heat stress and cold temperature adhesive performance and short set time. Surprisingly, the performance was not reduced when the adhesive usage was reduced by 50% while conventional hot melt composition exhibited significant loss in performance.

The above adhesives were used to seal boxes and tested for pull force and fiber tear.

Pull force is the amount of force required to destroy the bond, open the sealed box.

The percent fiber tear is the percent of the compressed adhesive bond area that is covered by the substrate fiber when two substrates bonded by the adhesive are pulled apart. A high percent fiber tear value indicates that the adhesive forms a strong bond with the substrate and thus indicative of the adhesive's high performance.

The adhesive was placed in a hot melt application equipment (tank, hose, gun, nozzle, compression rolls) and applied onto the flaps of a cardboard box while the box was moved by a conveyor belt. Example 1 and Comparative Example 1 were tested using bead weight (0.54 g/box), 30% reduction (0.38 g/box) and at 50% reduction (0.27 g/box). For each of the three adhesive weights, the boxes were tested 20 seconds after the adhesive was applied. The average pull force and fiber tears are shown in Table 3.

In addition, the boxes were conditioned at 0, 72 and 140° F. for 24 hours. The boxes were then tested for average pull force and fiber tear. The results are shown in Table 3.

TABLE 3
Performance

| | | Average Pull | | Average Fiber | |
|---|---|---|---|---|---|
| | | Force [lb] | | Tear [%] | |
| | | | Comp | | Comp |
| | | Ex 1 | Ex 1 | Ex 1 | Ex 1 |
| Full Bead | 72° F. [20 s] | 25 | 26 | 100 | 98 |
| | 0° F. [24 h] | 16 | 17 | 86 | 74 |
| | 72° F. [24 h] | 28 | 27 | 98 | 95 |
| | 140° F. [24 h] | 21 | 0 | 66 | 0 |
| 30 wt % bead reduction | 72° F. [20 s] | 21 | 15 | 98 | 86 |
| | 0° F. [24 h] | 14 | 0 | 84 | 25 |
| | 72° F. [24 h] | 21 | 22 | 98 | 87 |
| | 140° F. [24 h] | 16 | 0 | 52 | 0 |
| 50 wt % bead reduction | 72° F. [20 s] | 18 | 17 | 96 | 99 |
| | 0° F. [24 h] | 5 | 3 | 79 | 36 |
| | 72° F. [24 h] | 18 | 15 | 94 | 94 |
| | 140° F. [24 h] | 4 | 0 | 20 | 0 |

The average pull force at Full Bead in Table 3 was similar for both Example 1 and Comparative Example 1 except for 140° F. High pull force and high fiber tear is desirable to ensure that the package stays closed to protect the contents inside the package.

At 30 wt % bead reduction, Example 1 had superior average pull force and average fiber tear over Comparative Example 1, particularly for both ends of the temperature spectrums, 0° F. and 140° F.

Again, at 50 wt % bead reduction, Example 1 had superior average pull force and average fiber tear over Comparative Example 1, particularly for both ends of the temperature spectrums, 0° F. and 140° F.

1. A high performance hot melt adhesive composition comprising:
A. about 20 wt % to about 50 wt % of a polymer having (i) a melting point of about 105 to about 150° C. and (ii) a glass transition temperature of about −80 to about −50° C.;
B. about 20 to about 40 wt % of a wax; and
C. about 30 to about 70 wt % of a tackifier;
D. about 0.01 to about 3 wt % of an antioxidant; and
wherein the hot melt adhesive is substantially free of any plasticizer and
wherein the hot melt adhesive is substantially free of any other polymer having a DSC melting point of below about 105° C.

2. The high performance hot melt adhesive composition of claim 1, wherein the polymer has (i) a melting point of about 110 to about 140° C. and (ii) a glass transition temperature of about −70 to about −55° C.

3. The high performance hot melt adhesive composition of claim 1, wherein the polymer has (i) a melting point of greater than about 106° C.

4. The high performance hot melt adhesive composition of claim 1, wherein the polymer has a melt index of about 1 to about 30 g/10 min, measured at ASTM D 1238, 2.16 kg at 190° C.

5. The high performance hot melt adhesive composition of claim 1, wherein the viscosity of the adhesive is 2500 to about 10,000 cPs at 350° F. measured with a Brookfield viscometer No. 27 spindle.

6. The high performance hot melt adhesive composition of claim 1, wherein the polymer is an olefin block copolymer.

7. The high performance hot melt adhesive composition of claim 5, wherein the olefin block copolymer is an ethylene-propylene, ethylene-butene, ethylene-pentene, ethylene-hexene, ethylene-heptene, and ethylene-octene.

8. The high performance hot melt adhesive composition of claim 7, wherein the adhesive further comprises fillers, additives, pigments, dyestuffs, polymeric additives, defoamers, preservatives, thickeners, rheology modifiers, humectants, nucleating agent, antiblock, processing aids, UV stabilizers, neutralizers, lubricants, surfactants and adhesion promoters.

9. An article comprising two substrates and a high performance hot melt adhesive composition comprising:
A. about 20 wt % to about 50 wt % of a polymer having (i) a DSC melting point of about 110 to about 140° C. and (ii) a glass transition temperature of about −70 to about −55° C.;
B. about 20 to about 40 wt % of a wax;
C. about 30 to about 70 wt % of a tackifier; and
D. about 0.01 to about 3 wt % of an antioxidant;
wherein the hot melt adhesive is substantially free of any plasticizer;
wherein the hot melt adhesive is substantially free of any other polymer having a DSC melting point of below about 105° C.,
wherein the high performance hot melt adhesive has a heat stress value greater than 140 OF and has a adhesion tear value greater than 80% at −20° F. with bead weight of 0.075 g/in.

10. The article of claim 9, wherein each of the two substrate are independently selected from the group consisting of virgin and recycled Kraft paper, high and low density Kraft, chipboard, coated Kraft and chipboard, plastic film, wood, metal foil, release paper, cotton, nonwoven fabric, and composite film

11. The article of claim 10, wherein the substrate is selected from virgin and recycled Kraft paper, high and low density Kraft, and coated Kraft paper.

12. The article of claim 9, wherein the polymer has a melt index of about 1 to about 30 g/10 min, measured at ASTM D 1238, 2.16 kg at 190° C.

13. The article of claim 9, wherein the viscosity of the adhesive is 2500 to about 10000 cPs at 350° F. measured with a Brookfiled Visocister, spindle No. 27, and has a heat stress value greater than 140° F. in accordance with IoPP heat stress method.

14. The article of claim 9, wherein the polymer is an olefin block copolymer selected from the group consisting of ethylene-propylene, ethylene-butene, ethylene-pentene, ethylene-hexene, ethylene-heptene, and ethylene-octene.

15. The article of claim 14, wherein the polymer is ethylene-propylene or ethylene-octene.

16. The article of claim 9, wherein the adhesive further comprises fillers, additives, pigments, dyestuffs, polymeric additives, defoamers, preservatives, thickeners, rheology modifiers, humectants, nucleating agent, antiblock, processing aids, UV stabilizers, neutralizers, lubricants, surfactants and adhesion promoters.

17. The article of claim 9, which is a case, carton, tray, label, bookbinding, bag or disposable article.

18. A process for manufacturing an article comprising the steps of:
(A) forming a high performance adhesive composition comprising (i) about 20 wt % to about 50 wt % of a polymer having (a) a melting point of about 110 to about 140° C. and (b) a glass transition temperature of about −70 to about −55° C.; (ii) about 20 to about 40 wt % of a wax; (iii) about 30 to about 70 wt % of a tackifier; (iv) about 0.01 to about 3 wt % of an antioxidant; and wherein the adhesive is substantially free of any plasticizer and substantially free of any other polymer having a DSC melting point of below about 105° C.;
(B) applying the adhesive onto a substrate at about 275° F. to about 400° F.; and
(C) applying a second substrate onto the applied adhesive,
wherein the substrate is a paper, paperboard, plastic film, metal foil, release paper, cotton, or nonwoven fabric; and
wherein the viscosity of the adhesive is from about 2500 to about 10000 cPs at 350° F. measured in accordance to ASTM.
